(19) United States
(12) Patent Application Publication
(10) Pub. No.: US 2026/0273902 A1
(43) Pub. Date: Sep. 17, 2026

(54) TWO-PLY WEB AND PACKAGING AND METHODS FOR PRODUCING SAME

(71) Applicant: PROAMPAC HOLDINGS INC., Cincinnati, OH (US)

(72) Inventors: Bradley Lamers, Brillion, WI (US); Patrick A. Batten, New London, WI (US)

(21) Appl. No.: 19/557,968

(22) Filed: Mar. 5, 2026

Related U.S. Application Data
(60) Provisional application No. 63/772,410, filed on Mar. 14, 2025.

(51) Int. Cl. B32B 25/06; B65D 75/26

(52) U.S. Cl. CPC B32B 25/06; B65D 75/26; B32B 2250/05; B32B 2255/12; B32B 2255/26; B32B 2307/718; B32B 2439/06

(57) ABSTRACT

A packaging material assembly comprises first and second plies stacked in an unbonded configuration and extending across a packaging region and being free from a bonding layer over at least a majority thereof. The first ply comprises a first paper substrate having first and second opposing surfaces and a first heat sealable polymer layer on the second surface. The second ply comprises a second paper substrate having third and fourth opposing surfaces and a primer coating on the third surface comprising a polyalkyleneimine, and a second heat sealable polymer layer on the fourth surface. The first and second plies are configured for forming into a packaging container by joining at one or more heat seal regions, wherein the first and second plies remain substantially unbonded except at the one or more heat seal regions. In aspects, packaging blanks and packaging articles formed from the packaging material assembly are provided.

### CROSS REFERENCE TO RELATED APPLICATIONS

This application claims the priority benefit of U.S. Provisional Patent Application No. 63/772,410 filed Mar. 14, 2025. The aforementioned application is incorporated herein by reference in its entirety.

### BACKGROUND

The present disclosure relates to packaging materials and, in particular, to a two-ply non-laminated packaging material assembly and packaging articles formed therefrom.

### SUMMARY

In one aspect, a packaging material assembly comprises a first ply and a second ply arranged in an unbonded, stacked configuration. Each of the first ply and the second ply extend across a packaging region and are free from a bonding layer over at least a majority of the packaging region. The first ply comprises a first paper substrate having a first surface and second surface opposite the first surface and a first heat sealable polymer layer disposed on the second surface. The second ply comprises a second paper substrate having a third surface and fourth surface opposite the third surface, the second paper substrate having a primer coating disposed on the third surface and a second heat sealable polymer layer disposed on the fourth surface. The primer layer comprises a polyalkyleneimine. The first and second plies are configured to be formed into a packaging container by being joined at one or more heat seal regions, such that the first and second plies remain substantially unbonded except at the one or more heat seal regions.

In further aspect, packaging blanks and packaging articles formed from the packaging material assembly are provided.

In another aspect, method for producing packaging material assemblies, packaging blanks, and packaging articles are provided.

Various advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a front view of an exemplary two-ply packaging article formed from the packaging material assembly in accordance with the present disclosure.

FIG. 2 is cross-sectional view of the two-ply packaging article, taken along the lines 2-2 appearing in FIG. 1.

FIG. 3 is an enlarged cross-sectional view of the region 3 appearing in FIG. 2, illustrating the layered construction of the front panel.

FIG. 4 is an enlarged cross-sectional view of the region 4 appearing in FIG. 2, illustrating the layered construction of the rear panel.

FIG. 5 an enlarged cross-sectional view of the region 5 appearing in FIG. 2, illustrating the layered construction of the heat seal region.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, the terms “a” or “an,” are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

The term “directly contacts,” “in direct contact with,” “directly adhered to,” or similar terms as used herein, refers to a layer configuration whereby a first layer is located immediately adjacent to a second layer, the first layer touches the second layer, and no intervening layers, and/or no intervening structures, are present between the first layer and the second layer. The terms “indirectly contacts” or “in indirect contact with,” or similar terms as used herein, refers to a layer configuration whereby an intervening layer, or an intervening structure, is present between the first layer and the second layer.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5). Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to ±0.01%, from the specified amount, as such variations are appropriate in the disclosed materials and methods.

As used herein, the terms “front,” “rear,” “upper,” “lower,” “upwardly,” “downwardly,” “left,” “right,” and other orientation descriptors are intended to facilitate the description of the exemplary embodiments of the present invention and are not intended to limit the structure thereof to any particular position or orientation.

As used herein, the term “extrusion coating” is used in reference to a process wherein a molten polymer is extruded through a die and applied as a coating onto a substrate to form a coated substrate.

As used herein, the term “packaging structure” means a web of sheet material having a structure as disclosed herein, as well as a packaging article manufactured therefrom, including sheets, envelops, bags, pouches, and the like.

All compositional percentages used herein are presented on a “by weight” basis, unless specifically stated otherwise.

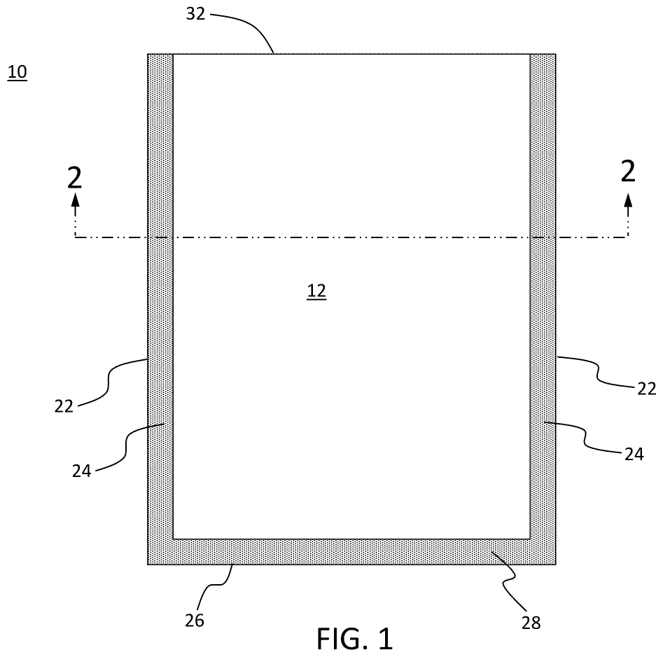

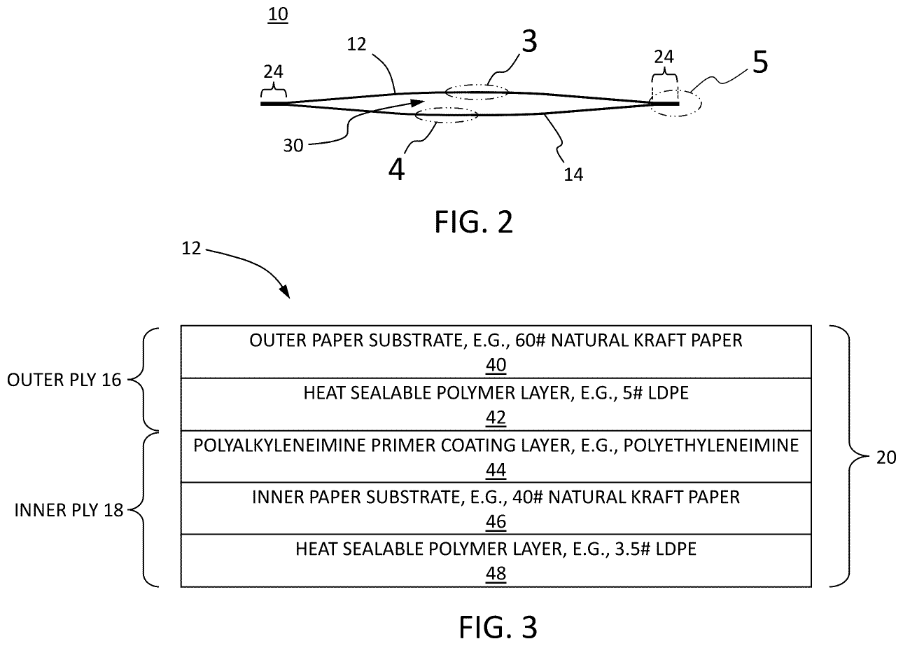

Referring now to FIGS. 1 and 2, there appears an exemplary packaging structure 10. The packaging structure 10 is depicted as a three side seal pouch, preferably a three side seal flat pouch, for the purpose of depicting one manner in which the non-laminated packaging assembly in accordance with the present disclosure can be implemented. This illustration is not meant to limit the manner in which the non-laminated packaging assembly herein can be implemented.

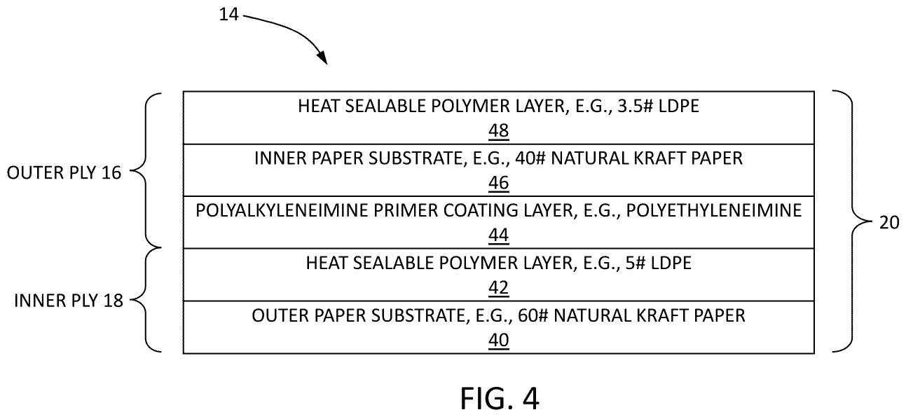

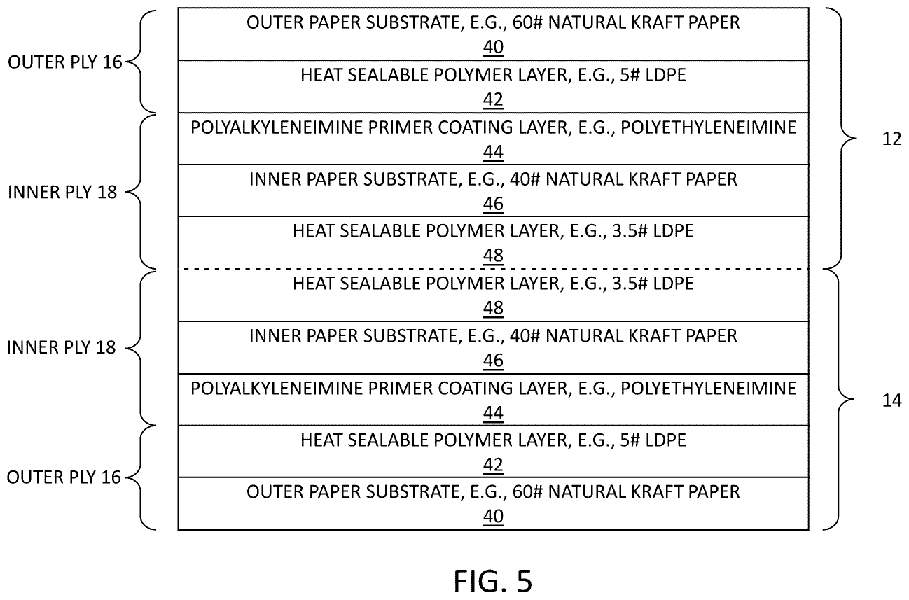

The packaging structure 10 includes a front panel 12 and an opposing rear panel 14. The front panel 12 and the opposing rear panel 14 each comprise two non-laminated webs of material, namely an outer ply 16 and an inner ply 18 which are stacked to form a non-laminated assembly 20 (see FIGS. 3 and 4).

The front and rear panels 12, 14 are sealed along opposing side edges 22 by heat sealing to form opposing, longitudinally extending side heat seal regions 24. The front and rear panels 12, 14 are sealed along a bottom edge 26 by heat sealing to form a transverse bottom heat seal region 28. The heat seal regions 24 and 28 define a package interior compartment 30. In alternative embodiments, the front and rear panels 12, 14 may be formed from a single sheet of material that is folded upon itself, wherein the bottom heat seal region 28 is omitted such that the fold line closes the bottom edge 26 of the structure 10. The packaging structure is open at its upper edge 32 to provide access to the interior compartment 30. After contents have been placed into the interior compartment 30, the upper edge 32 may be closed using any suitable closure means, such as a transverse heat seal, adhesive, closure flap, interlocking zipper closure, or other closure mechanism.

Referring now to FIGS. 3 and 4, and with continued reference to FIGS. 1 and 2, there is shown a cross-sectional view of an exemplary non-laminated web structure 20 operable to form the front panel 12 or the rear panel 14. The layer construction of the structure 20 in FIGS. 3 and 4 are the same except that the structure 20 appearing in FIG. 4 is in an inverted orientation relative to the structure 20 appearing in FIG. 3, depicted the relative orientation in the packaging article 10.

The outer ply 16 is configured to face toward the exterior of the packaging structure 10 and the inner ply 18 is configured to face toward the interior compartment 30 and the contents of the packaging structure 10.

The outer ply 16 includes an outer paper substrate 40. The outer paper substrate 40 can be printed on its outward facing surface. A coating layer 42 formed of a heat sealable polymer is disposed on the inward facing surface of the outer paper substrate 40.

In preferred embodiments, the heat sealable polymer layer 42 is applied to the outer paper substrate 40 using an extrusion coating process. In alternative embodiments, the heat sealable polymer layer 42 is applied to the outer paper substrate 40 using another technique such as wet coating, spray coating, thermal lamination, or the like.

The inner ply 18 includes an inner paper substrate 46. A coating layer 48 formed of a heat sealable polymer is disposed on the inward facing surface of the inner paper substrate 46. In embodiments, the heat sealable polymer layer 48 is applied to the inner paper substrate 40 using an extrusion coating process. In alternative embodiments, the heat sealable polymer layer 42 is applied to the outer paper substrate 40 using another technique such as wet coating, spray coating, thermal lamination, or the like. A primer coating layer 44 is applied to the outward facing surface of the inner paper substrate 46. Preferably, at least the outward facing surface of the inner paper substrate 46 is uncoated prior to application of the primer layer 44.

In embodiments, each of the inner and outer paper substrates, which may be the same or different, may be formed of any suitable paper, including but not limited to Kraft paper, including bleached and unbleached (natural) Kraft paper, wood free paper, bleached wood free paper, sulfite paper, bleached sulfite paper, hardwood paper, bleached hardwood paper, mechanical paper, bleached mechanical paper, recycled paper, bleached recycled paper, cotton paper, bleached cotton paper, bond paper, bleached bond paper, parchment paper, bleached parchment paper, and others. In preferred embodiments, the inner and outer paper substrates are formed of virgin natural Kraft paper, although inner and outer paper substrates formed of Kraft paper or other types of paper containing recycled fibers are also contemplated.

In embodiments, the outer paper substrate 40 has a basis weight which is greater than the basis weight of the inner paper substrate 46. In embodiments, the basis weight of the outer paper substrate 40 is in the range of from about 30 #(pounds per ream) to about 120 #, preferably from about 40 #to about 100 #, and more preferably about 60 #. In embodiments, the inner paper substrate 46 may have a basis weight ranging from about 20 #to about 80 #, preferably from about 30 #to about 60 #, and more preferably about 40 #.

In preferred embodiments, the outer paper substrate 40 has a basis weight which is greater than the basis weight of the inner paper substrate 46. In the presently preferred embodiment, the outer paper substrate 40 is formed of Kraft paper having a basis weight of 60 pounds per ream and the inner paper substrate 46 is formed of Kraft paper having a basis weight of 40 pounds per ream.

Unless specifically stated otherwise, all references to “ream” with respect to basis weights herein refer to a 3000 square foot ream.

In embodiments, each of the heat sealable polymer layers 42 and 48, which may be the same or different, is formed of a polymer material selected

In preferred embodiments, the outer paper substrate 40 is formed of Kraft paper having a basis weight of 60 pounds per ream and the inner paper substrate 46 is formed of Kraft paper having a basis weight of 40 pounds per ream.

In embodiments, each of the heat sealable polymer layers 42 and 48, which may be the same or different, is formed of a suitable polymer material having good heat seal qualities.

In embodiments, the heat sealable polymer layers each have a coating weight, which may be the same or different, in the range of 2 #/ream to 20 #/ream, e.g., 1 #/ream, 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, or 20 #/ream.

In preferred embodiments, the heat sealable polymer layers each have a coating weight, which may be the same or different, in the range of 4 #/ream to 6 #/ream.

Unless specifically stated otherwise, all references to “ream” with respect to coating weights herein refer to a 3000 square foot ream.

In certain embodiments, the polymer material forming the heat sealable polymer layers 42 and 48, which may be the same or different, is formed of a polyolefin-based polymer or copolymer material, preferably a polyethylene-based or polypropylene-based polymer material. In embodiments, the polymer material forming the heat sealable polymer layers 42 and 48 comprises a monomaterial or a polymer blend. In certain embodiments, polymer material forming the heat sealable polymer layers 42 and 48 is selected from polypropylene homopolymer, high-density polyethylene (HDPE), medium density polyethylene (MDPE), linear medium density polyethylene (LMDPE), low-density polyethylene (LDPE), linear low-density polyethylene (LLDPE), very low-density polyethylene (VLDPE), metallocene linear low-density polyethylene (mLLDPE), polyolefin plastomer (POP), metallocene polypropylene (mPP), cast polypropylene (CPP), polypropylene/polyethylene random copolymer, polyethylene/polypropylene random copolymer, polypropylene/polyethylene block copolymer, polyethylene/polypropylene block copolymer, or blends or coextrusions of any of the foregoing.

The heat sealable polymer layer may be formed as a monolayer extrusion coating or a multilayer coextrusion coating. In the case of a monolayer extrusion coating, the sealant layer may be a blend of one or more heat sealable polymeric materials as described. In the case of a multilayer coextrusion coating, the individual sublayers may comprise the same or different heat sealable polymeric materials.

In preferred embodiments, the heat sealable polymer layers 42 and 48 are formed of LDPE. In preferred embodiments, the heat sealable polymer layer 42 is formed of LDPE having a coating weight of 5 pounds per ream and the heat sealable polymer layer 48 is formed of LDPE having a coating weight of 3.5 pounds per ream.

The polyalkyleneimine primer layer 44 is applied to the outward facing surface of the inner paper substrate 18. The polyalkyleneimine primer is preferably a polyethyleneimine primer. The polyalkyleneimine primer may be applied using any suitable coating process for water-based or solvent-based coatings, including but not limited to flexographic coating, roll coating, roll-to-roll coating, gravure coating (direct or offset), bar coating, doctor blade coating, comma coating, slot-die coating, knife-over-roll coating, reverse roll coating, spray coating, air knife coating. In the preferred embodiments, the polyalkyleneimine primer is applied using a flexographic coating process.

In embodiments, the polyalkyleneimine primer is applied in the form of a water based or solvent based formulation. In embodiments, the polyalkyleneimine primer formulation comprises about 5% solids by weight of the formulation. In embodiments, the primer formulation is applied to the outward facing surface of the inner paper substrate at a specific wet weight such that, after drying to remove the water or solvent carrier, the resultant primer coating has a coating weight in the range of from 0.1 to 2.0 pounds per ream, and more preferably, in the range of 0.3 to 0.6 pounds per ream. In preferred embodiments, the primer formulation is a water based formulation, e.g., due to concerns related to volatile organic compounds (VOCs) and their environmental impact.

Referring now to FIG. 4, and with continued reference to FIGS. 1-3, there is shown an enlarged view of the heat seal region 24. Prior to heat sealing the front and rear panels 12, 14, for each of the panels 12 and 14, the outer ply 12 is unbonded to the inner ply 18. Likewise, prior to the heat sealing step, the inner ply 18 of the front panel 12 is unbonded to the facing inner ply 18 of the rear panel 14.

When the panels 12 and 14 are formed into the packaging article 10 by heat sealing at a specified sealing temperature, sealing pressure, and dwell time, the outer ply 16 and the inner ply 18 of the front panel 12 are joined in the heat seal regions 24 and 28, e.g., by thermal bonding of the heat sealable polymer layer 42 to the primer-coated surface of the corresponding paper substrate 46 of the inner ply 18, where the primer layer 44 serves as an intermediate layer that facilitates adhesion between the heat sealable polymer layer 42 and the inner paper substrate 46 of the inner ply 18.

In addition, the heat sealing process also joins the outer ply 16 and the inner ply 18 of the rear panel 14 in the heat seal regions 24 and 28, e.g., by thermal bonding of the heat sealable polymer layer 42 to the primer-coated surface of the corresponding paper substrate 46 of the inner ply 18, where the primer layer 44 serves as an intermediate layer that facilitates adhesion between the heat sealable polymer layer 42 and the inner paper substrate 46 of the inner ply 18.

Finally, the heat sealing process joins by heat sealing the heat sealable polymer layer 48 of the inner ply 18 of the front panel 12 to the heat sealable polymer layer 48 of the inner ply 48 of the rear panel 14 in the heat seal regions 24 and 28.

After heat sealing, the front panel 12 and rear panel 14 remain unbonded except at the seal regions 24 and 28. Likewise, after heat sealing, respective outer ply 16 and the inner ply 18 of each of the front and rear panels 12, 14 remain unbonded except at the seal regions 24 and 28.

An exemplary method for the manufacture of a web operable to form the front panel 12 and the rear panel 14 comprises providing a roll of the outer paper substrate and extrusion coating a heat sealable polymer onto a surface of the outer paper substrate. Optionally, the coated paper web for forming the outer ply 16 so produced can be fed to a take up roll for later use. In addition, a roll of the inner paper substrate is provided and a heat sealable polymer is extrusion coated onto a first surface of the inner paper substrate. A wet coating of a polyalkyleneimine primer formulation is applied to a second surface of the inner paper substrate followed by drying, e.g., heat and/or air drying. Optionally, the coated paper web for forming the inner ply 18 so produced can be fed to a take up roll for later use. In certain embodiments, the extrusion coating layer 48 is pre-applied and the primer coating layer 44 is applied in a subsequent processing step. In certain embodiments, the primer coating layer 44 is pre-applied and the extrusion coating layer 48 is applied in a subsequent processing step. In certain embodiments, the extrusion coating layer 48 and the primer coating layer 44 are applied in a single process line. Finally, the coated paper web for forming the outer ply 16 and the coated paper web for forming the inner ply 18 are brought together to form an unbonded, stacked assembly wherein the heat sealable layer 42 of the outer ply 16 is facing and directly adjacent the primer coating layer 44 of the inner ply 18.

An exemplary method for the manufacture of a packaging article comprises bringing together first and second unbonded, stacked assemblies as described above so that the heat sealable polymer layer 48 of the inner ply 18 of the first unbonded, stacked assembly is facing and directly adjacent the heat sealable polymer layer 48 of the inner ply 18 of the second unbonded, stacked assembly. It will be recognized that the first and second unbonded, stacked assemblies may originate from separate webs, each of which is fed through the processing system independently. Alternatively, the first and second unbonded, stacked assemblies may be derived from a single web which is folded over upon itself. In either case, after the first and second unbonded, stacked assemblies are aligned, they are bonded in the heat seal regions 24, 28 to provide the two-ply packaging structure 10.

To evaluate the performance of the packaging material assembly in accordance with the present disclosure, a series of tests were conducted to measure the seal strength, namely, maximum load at seal failure and average load at seal failure. A control structure and the presently disclosed structure were tested under identical conditions.

In the structures below, KP is Kraft paper, PEI is polyethyleneimine, a “/” (slash) between adjacent layers indicates that the adjacent layers are bonded together, and a “-” (hyphen) between adjacent layers indicates that the adjacent layers are adjacent or stacked but not laminated or bonded.

A two-ply control structure comprising a non-laminated material having the following structure was fabricated:

$$60 \# KP / 5 \# LDPE - 40 \# KP / 3.5 \# LDPE$$

A heat-sealed control structure having a heat seal width of 1 inch was then formed by applying sealing conditions to two layers of the two-ply control structure at a sealing temperature of 350° F. (177° C.), a sealing pressure of 40 psi, and a dwell time of 0.5 seconds. The heat sealed control structure had the following structure:

$$60 \# KP / 5 \# LDPE / 40 \# KP / 3.5 \# LDPE / 3.5 \# LDPE / 40 \# KP / 5 \# LDPE / 60 \# KP$$

A two-ply structure in accordance with the present disclosure comprising a non-laminated material having the following structure was fabricated:

$$60 \# KP / 5 \# LDPE - PEI / 40 \# KP / 3.5 \# LDPE$$

A heat-sealed structure having a heat seal width of 1 inch in accordance with the present disclosure was then formed by applying sealing conditions to two layers of the presently disclosed two-ply structure at a sealing temperature of 350° F. (177° C.), a sealing pressure of 40 psi, and a dwell time of 0.5 seconds. The presently disclosed heat sealed structure had the following structure:

$$60 \# KP / 5 \# LDPE / PEI / 40 \# KP / 3.5 \# \text{} LDPE / 3.5 \# LDPE / 40 \# KP / PEI / 5 \# LDPE / 60 \# KP$$

Seal strength tests were conducted using a tensile unit at speed of 100 mm/min to measure maximum load at failure and average load at failure for both the control heat seal structure and the presently disclosure heat seal structure. The results of the test are summarized in Table 1 below.

TABLE 1

| | Maximum Load | Average Load |
|---|---|---|
| Sample | (gram-force/inch) | (gram-force/inch) |
| Heat-sealed control structure | 729 | 325 |
| Presently disclosed heat | 1223 | 622 |
| sealed structure | | |

The results demonstrated a significant improvement in seal strength for the presently disclosed structure compared to the control structure. Specifically, the maximum load for the present structure increased by 67% and the average load increased by 91.5% over the control structure. These results highlight the effectiveness of the packaging material assembly of the present disclosure in providing superior seal strength, which is a desirable characteristic for packaging applications.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A packaging material assembly comprising:
a first ply and a second ply arranged in an unbonded, stacked configuration;
each of the first ply and the second ply extending across a packaging region and being free from a bonding layer over at least a majority of the packaging region;
the first ply comprising a first paper substrate having a first surface and second surface opposite the first surface and a first heat sealable polymer layer disposed on the second surface;
the second ply comprising a second paper substrate having a third surface and fourth surface opposite the third surface, the second paper substrate having a primer coating disposed on the third surface and a second heat sealable polymer layer disposed on the fourth surface, the primer layer comprising a polyalkyleneimine;
wherein the first and second plies are configured to be formed into a packaging container by being joined at one or more heat seal regions, such that the first and second plies remain substantially unbonded except at the one or more heat seal regions.

2. The packaging material assembly of claim 1, wherein the primer layer comprising a polyalkyleneimine is configured to improve a bond strength between the first heat sealable polymer layer and the third surface of the second paper substrate in the one or more heat seal regions when the first and second plies are formed into a packaging container by being joined at one or more heat seal regions.

3. A packaging blank comprising:
first and second packaging material assemblies, each in accordance with claim 1, in combination;
the first packaging material assembly and the second packaging material assembly arranged in an unbonded, stacked configuration wherein the second heat sealable polymer layer of the first packaging material assembly is facing and directly adjacent the second heat sealable polymer layer of the second packaging material assembly;
wherein the first and second packaging material assemblies are configured to be formed into a packaging container by being joined at the one or more heat seal regions, such that the first and second packaging material assembly substantially remain unbonded except at the one or more heat seal regions.

4. A packaging article formed from the packaging blank of claim 3.

5. The packaging article of claim 4, wherein the packaging article is a three side seal pouch.

6. The packaging material assembly of claim 1, wherein the first paper substrate and the second paper substrate, which may be the same or different, are selected from the group consisting of bleached Kraft paper, unbleached Kraft paper, wood free paper, bleached wood free paper, sulfite paper, bleached sulfite paper, hardwood paper, bleached hardwood paper, mechanical paper, bleached mechanical paper, recycled paper, bleached recycled paper, cotton paper, bleached cotton paper, bond paper, bleached bond paper, parchment paper, bleached parchment paper, virgin unbleached Kraft paper, virgin bleached Kraft paper, unbleached Kraft paper containing recycled fibers, and bleached Kraft paper containing recycled fibers.

7. The packaging material assembly of claim 1, wherein the first paper substrate and the second paper substrate, which may be the same or different, are formed of an unbleached Kraft paper or a bleached Kraft paper.

8. The packaging material assembly of claim 7, wherein the first paper substrate is formed of a 60 #bleached or unbleached Kraft paper and the second paper substrate is formed of a 40 #bleached or unbleached Kraft paper.

9. The packaging material assembly of claim 7, wherein the first paper substrate and the second paper are each formed of virgin unbleached Kraft paper.

10. The packaging material assembly of claim 1, wherein the first heat sealable polymer layer and the second heat sealable polymer layer, which may be the same or different, are formed of a polyolefin-based polymer.

11. The packaging material assembly of claim 10, wherein the first heat sealable polymer layer and the second heat sealable polymer layer, which may be the same or different, are formed of a polyolefin-based polymer selected from the group consisting of polypropylene-based polymers, polypropylene-based copolymers, and polyethylene-based polymers, and polyethylene-based copolymers, and any combination thereof.

12. The packaging material assembly of claim 10, wherein the first heat sealable polymer layer and the second heat sealable polymer layer, which may be the same or different, are formed of a polyolefin-based polymer selected from the group consisting of polypropylene homopolymer, high-density polyethylene (HDPE), medium density polyethylene (MDPE), linear medium density polyethylene (LMDPE), low-density polyethylene (LDPE), linear low-density polyethylene (LLDPE), very low-density polyethylene (VLDPE), metallocene linear low-density polyethylene (mLLDPE), polyolefin plastomer (POP), metallocene polypropylene (mPP), cast polypropylene (CPP), polypropylene/polyethylene random copolymer, polyethylene/polypropylene random copolymer, polypropylene/polyethylene block copolymer, polyethylene/polypropylene block copolymer, and any blend or coextrusion of any of the foregoing.

13. The packaging material assembly of claim 12, wherein the first heat sealable polymer layer and the second heat sealable polymer layer, which may be the same or different, are formed of low density polyethylene (LDPE).

14. The packaging material assembly of claim 1, wherein each of the first heat sealable polymer layer and the second heart sealable polymer layer has a coating weight in the range of from about 2 pounds per ream to about 20 pounds per ream.

15. The packaging material assembly of claim 14, wherein the first heat sealable polymer layer has a coating weight in the range of from about 4 pounds per ream to about 6 pounds per ream and the second heart sealable polymer layer has a coating weight in the range of from about 2.5 pounds per ream to about 6 pounds per ream.

16. The packaging material assembly of claim 15, wherein the first heat sealable polymer layer has a coating weight of 5 pounds per ream and the second heat sealable polymer layer has a coating weight of 3.5 pounds per ream.

17. The packaging material assembly of claim 1, wherein the primer layer comprises a polyethyleneimine.

18. A method comprising a method for the manufacture of a packaging material assembly, comprising:
providing an outer paper substrate;
extrusion coating a heat sealable polymer layer onto a first surface of the outer paper substrate to provide a coated outer paper substrate;
providing an inner paper substrate;
extrusion coating a heat sealable polymer layer onto a first surface of the inner paper substrate;
applying a wet coating of a polyalkyleneimine primer formulation to a second surface of the inner paper substrate;
drying the wet coating of a polyalkyleneimine primer formulation to form a coated inner paper substrate having a primer coating on the second surface of the inner paper substrate;
bringing together the coated outer paper substrate and the coated inner paper substrate to form a first unbonded, stacked assembly wherein the heat sealable polymer layer of the coated outer paper substrate is facing and directly adjacent the primer coating on the second surface of the inner paper substrate.

19. The method of claim 18, further comprising:
bringing the first unbonded, stacked assembly together with a second like unbonded, stacked assembly so that the heat sealable polymer layer of the coated inner paper substrate of the first unbonded, stacked assembly is facing and directly adjacent the heat sealable polymer layer of the coated inner paper substrate of the second like unbonded, stacked assembly.

20. The method of claim 19, wherein the first unbonded, stacked assembly and the second like unbonded, stacked assembly are formed of a contiguous assembly and separated by a fold line wherein contiguous assembly is folded about said fold line so that the second like unbonded, stacked assembly overlies the first unbonded, stacked assembly.

21. The method of claim 19, wherein the first unbonded, stacked assembly and the second like unbonded, stacked assembly are formed from separate webs.

22. The method of claim 19, further comprising bonding the first unbonded, stacked assembly and the second like unbonded, stacked assembly in at least one heat seal region under sealing conditions of temperature, pressure, and time to form a packaging article.
